(19) United States
(12) Patent Application Publication
(10) Pub. No.: US 2023/0196808 A1
(43) Pub. Date: Jun. 22, 2023

(54) Code reader and method of reading an optical code

(71) Applicant: SICK AG, Waldkirch (DE)

(72) Inventors: Marcel HAMPF, Waldkirch (DE); Pascal SCHUELER, Waldkirch (DE)

(21) Appl. No.: 18/084,664

(22) Filed: Dec. 20, 2022

(30) Foreign Application Priority Data
Dec. 21, 2021 (EP) 21216207.7

(51) Int. Cl. G06V 30/148; G06V 10/22; G06V 10/60

(52) U.S. Cl. CPC G06V 30/153; G06V 10/22; G06V 10/60

(57) ABSTRACT

A method of reading an optical code is provided in which a brightness profile of the code is recorded, light and dark part regions are identified in the brightness profile, and the code content of the optical code is read, First sum measurements for the light quantity in the respective light part regions and second sum measurements for the light quantity lacking for a white level in the respective dark part regions are determined from the brightness profile and the code content is read based on the first and second sum measurements.

The invention relates to a method of reading an optical code in which a brightness profile of the code is recorded, light and dark part regions are identified in the brightness profile, and the code content of the optical code is read, and to a code reader for reading optical codes that has a light receiver for detecting a brightness profile of the optical code and a control and evaluation unit that is configured to identify light part regions and dark part regions in the brightness profile and to read the code content of the optical code.

Code readers are known from supermarket checkouts, for automatic parcel identification, for sorting mail shipments, from baggage handling at airports, and from other logistics applications. In a code scanner, a reading beam is guided transversely over the code by means of a rotating mirror or by means of a polygon mirror wheel. A camera-based code reader records images of the objects having the codes located thereon with the aid of an image sensor and image evaluation software extracts the code information from these images. Camera-based code readers also cope without problem with different code types than one-dimensional barcodes which also have a two-dimensional structure like a matrix code and provide more information.

In an important application group, the objects bearing the code are conveyed past the code reader. A code scanner here detects the respective codes successively led into its reading zone. Alternatively, in a camera-based code reader, a line scan camera reads in the object images having the code information successively and linewise with the relative movement. As a rule, image data are recorded using a two-dimensional image sensor that overlap more or less depending on the recording rate and on the conveying speed. So that the objects can be arranged in any desired orientation on the conveyor, a plurality of code readers are often provided at a reading tunnel to record objects from a plurality of sides or from all sides.

A gray scale value profile is recorded over a line transverse to the barcode for decoding a barcode. A multiple evaluation over a plurality of lines frequently takes place. The code elements, that is the light and dark bars or lines, are classified by their widths and are arranged in rows in accordance with their positions. The classification has the objective here of determining the multiple of the width with respect to a smallest code element or a narrowest bar since the code content is thereby fixed.

The gray scale value profile is binarized for this evaluation, i.e. is converted into a black and white profile using a gray scale value threshold. In the case of an ideal binarization, the value of zero is produced for all the dark bars and the value of one for all the light bars so that the classification follows on directly and unambiguously from the length of the sequences of zeroes and ones. Dynamic gray scale value thresholds are inter alia used to come as close as possible to this ideal case. Since a respective bar boundary is a transition from light to dark or vice versa, the gray scale value profile is often differentiated to localize these transitions or edges.

However, the transitions between the bars can no longer be localized so unambiguously in the gray scale value profile of an actually recorded barcode. The possible causes of blur include incorrect focusing, too low a resolution, and motion artifacts (motion blur). The transitions or edges are then blurred or washed out, pixels or pixel groups register light from a plurality of adjacent code elements.

The effects on resolutions under one pixel per code element that are too low can be seen particularly clearly when the sampling theorem has been infringed. The number of pixels per smallest code element, narrowest bar, or module is called the module size. If, for example, a bar is detected centrally on a pixel with a module size of one, the width one is measured for this purpose after binarization. If, however, the same bar is detected between two pixels, the light is distributed over two pixels and a width two is measured and thus incorrectly classified. This effect is shown with higher module sizes in a relatively weaker, but still relevant amount.

Modules or code elements or bars are consequently no longer detected at all under certain circumstances or their widths and positions become too imprecise. This prevents successful code reading from a certain level onward. The problems described for the example of barcodes occur in a similar manner with 2D codes.

It is therefore the object of the invention to improve the decoding of an optical code.

This object is satisfied by a method of reading an optical code and by a code reader in accordance with the respective independent claim. The optical code can be a barcode, but also a two-dimensional code in accordance with one of the various known standards. A brightness profile or a gray scale value profile of the code is recorded. With a barcode it is a one-dimensional function of brightness values or gray scale values along a line transversely across the barcode, for example values from 0 to 255 with an 8 bit encoding of the brightness values. With a 2D code a corresponding brightness profile is detected over two spatial dimensions that can be designated without any restriction of generality as X and Y, with then the brightness being able to be entered graphically in the Z direction.

Light and dark part regions are identified in the brightness profile. This can be done, for example, using a binarization profile, a search for light/dark transitions, for example by differentiating the brightness profile or by minima and maxima.

The code content of the optical code is then read. The extent and position of the light and dark part regions would conventionally be determined for this purpose.

The invention starts from the basic idea of determining sum measurements of the light and dark regions to determine the code content. The brightness profile measures the spatial distribution of the detected light quantity. First sum measurements are determined for the light quantity in the respective light part regions. Second sum measurements determine the light quantity lacking for a white level, in particular a maximum level, in a complementary manner in the respective dark part regions. It is therefore inverted for the second sum measurements and thus explicitly not summed over the brightness profile itself; that would be a summing over values that are ideally zero so that the second sum measurements remain very imprecise. A first sum measurement per light part region and a second sum measurement per dark part region are preferably respectively determined. The code content is then determined while including the first and second sum measurements. The information of the first and second sum measurements is preferably sufficient on its own to read the code content.

The invention has the advantage that a substantially more robust determination of code elements or individual modules is made possible in extent and position and indeed even when the optical code could only be recorded as blurred, at low resolution, or washed out. More optical codes accordingly become readable; the reading rate as the major performance parameter in code reading increases. The influence of sampling effects, blur, and motion artifacts explained in the introduction is reduced and the decoding of individual detections of a brightness profile is even made possible below the resolution boundary of one pixel per module or of a module size of one.

The respective brightness profile between two of its minima, preferably between two adjacent minima, is preferably summed for the first sum measurements. A respective first sum measurement accordingly collects the light quantity of a light part region so-to-say from valley to valley over the total mountain. The minimum here is initially to be understood broadly as a point in this valley and only preferably as the minimum in the strict mathematical sense. For example, the center between a falling and a subsequently climbing flank could also be used. To be able to sum from minimum to minimum, a search for minima or valleys in the brightness profile preferably takes place beforehand.

The respective brightness profile between two of its maxima, preferably between two adjacent maxima, is preferably summed for the second sum measurements. The statements of the preceding paragraph apply accordingly, with now so-to-say summing taking place from mountain to mountain or from peak to peak of the brightness profile.

The brightness profile is preferably inverted to determine the second sum measurements and is compensated by an offset corresponding to the white level. This is actually only an illustration; the calculation of the lacking light quantity can take place in any desired manner. Through the inversion, for example by multiplying by −1, the lacking light quantities now form peaks or maxima instead of valleys or minima as before, but with negative values. To reach the positive range again, the inverted brightness profile is corrected upwardly by the white level. The second sum measurements can now be determined in the inverted shifted brightness profile in exactly the same way as the first sum measurements in the original brightness profile.

The first sum measurements and/or the second sum measurements are preferably determined by integration. An integral with the X axis can be formed as customary as a reference in the light part regions. In the dark part regions the reference axis is upwardly offset at the white level. How this can be returned to a customary integral by inversion and an offset corresponding to the white level has already been described. Since the brightness profile is discrete in practice, without thus precluding an analog detection or conversion into a continuous brightness profile, the integration is typically likewise discrete, a summing of the sampling values in the light or dark part regions.

The code content is preferably determined from an alternating sequence of the first sum measurements and the second sum measurements. Light part regions and dark part regions alternate in the brightness profile. If the sum measurements are accordingly arranged alternately in the order specified by the brightness profile, the code content can be read therefrom. The numerical values of the sum measurements should here preferably be pre-processed as presently presented in advantageous embodiments.

The first sum measurements and the second sum measurements are preferably classified, in particular with reference to a reference value estimated from at least one finest sum measurement. The respective multiple of the extent with respect to a reference value of a smallest module or narrowest bar of the optical code is determined from the sum measurements by the classification. This then produces the sequence of the code elements and ultimately the code content. The classes are therefore preferably predefined by multiples of the reference value. The respective finest or smallest sum measurement, irrespective of whether a first or second sum measurement, enables the estimation of the reference value or the i smallest sum measurements are used and averaged, for example, for this purpose. In principle, every known classifier can be used, including methods of artificial intelligence or of machine reading or neural networks.

The first sum measurements and the second sum measurements are preferably divided discretized by a reference value and then, with the reference value in particular being estimated from at least one finest sum measurement. This is a specific, very simple possibility of the classification as a multiple of the reference value. The sum measurements are here standardized or discretized to the reference value in a simple manner.

The optical code is preferably a 2D code and in particular the first sum measurements and the second measurements are determined in an environment of minima or maxima up to a brightness boundary determined by a threshold value. In the two-dimensional case, the minima and maxima lie in a kind of two-dimensional landscape. A sensible summing boundary or integration boundary should therefore be specified for every light or dark part region. In this advantageous embodiment, this is specified by the brightness boundary that the brightness value exceeds in the case of the first sum measurements coming from the minimum and falls below in the case of the second sum measurements coming from the maximum. The relevant neighborhoods of the respective peaks or valleys of the light and dark part regions are thus delineated by the brightness boundary. It is conceivable to set different threshold values for the light or dark part regions.

The brightness profile is preferably divided into subsections in which respective first sum measurements and second sum measurements are determined, in particular rectangular subsections, rows, or columns. The method in accordance with the invention is thus applied to different part sections of the optical code, preferably not only with respect to the determination of sum measurements, but also to the alternating arrangement and classification as described above. The subdivided application of the method in accordance with the invention is particularly interesting for 2D codes. Small rectangles, but also columns, rows, or other linear subdivisions are exemplary subdivisions since the latter can then respectively be processed as a 1D case or barcode, with the part regions finally being combined.

The brightness profile is preferably divided multiple times into different subsections to determine first and second sum measurements multiple times, with the results being offset or compared with one another, in particular by a logical link. A plurality of different subdivisions are therefore applied and the results subsequently consolidated. In this respect, for example, the brightness boundary introduced above can be varied or, in a particularly preferably embodiment, two subdivisions into columns and rows are carried out. An advantageous step in the offsetting of the results is a logical link, for example an AND or an OR.

The code reader in accordance with the invention for reading optical codes has a light receiver for detecting a brightness profile. It can be the light receiver of a code scanner, a line sensor for detecting a code line or a planar code image by assembling image rows, or a matrix sensor. A plurality of camera heads whose images are assembled is also conceivable. The further evaluation steps, in particular those of the method in particular in one of its advantageous embodiments, are them implemented in a control and evaluation unit that can itself be part of a barcode scanner or of a camera-based code reader or can be connected thereto as a control device. Light and dark part regions are consequently identified in the brightness profile and the code content of the optical code is read. For this purpose, first sum measurements for the light quantity in the respective light part regions and second sum measurements for the light quantity lacking for a white level are determined in the respective dark part regions from the brightness profile and the reading of the code content is based on the first and second sum measurements.

The invention will be explained in more detail in the following also with respect to further features and advantages by way of example with reference to embodiments and to the enclosed drawing. The Figures of the drawing show in:

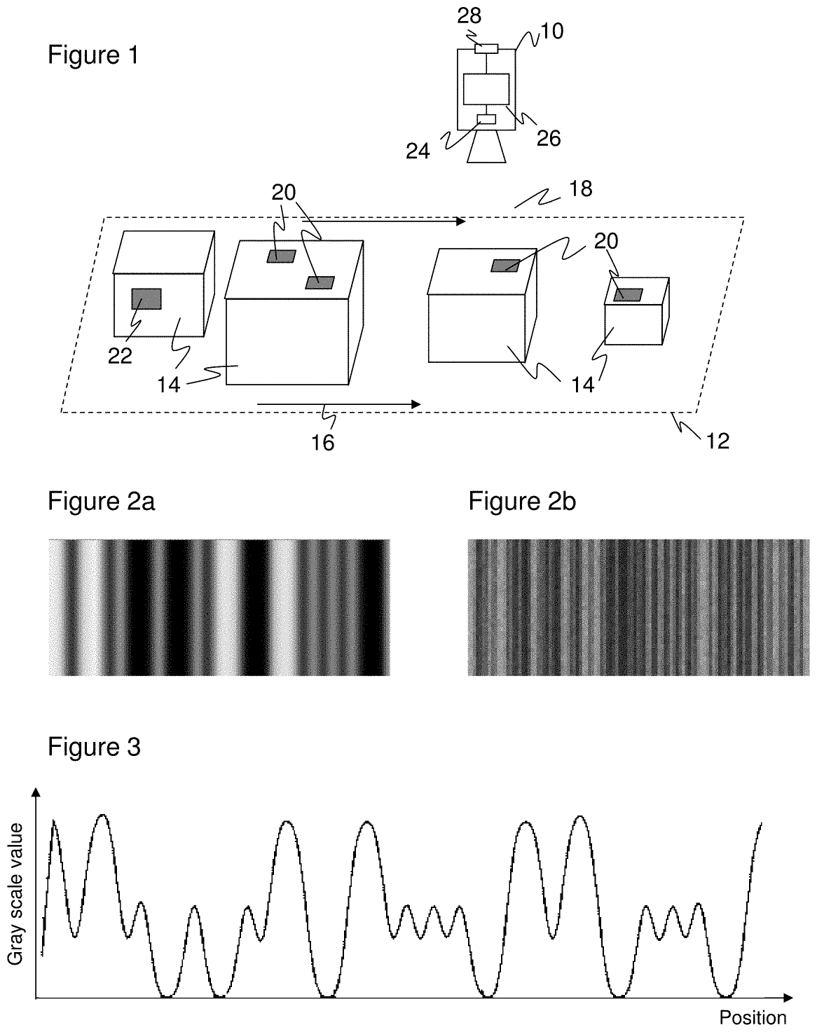

FIG. 1 a schematic three-dimensional overview representation of the exemplary installation of a code reader above a conveyor belt on which objects having codes to be read are conveyed:

FIG. 2a an example of a barcode recorded in washed out form;

FIG. 2b an example of a barcode recorded with low resolution;

FIG. 3 an exemplary gray scale value profile for the washed out barcode in accordance with FIG. 2a;

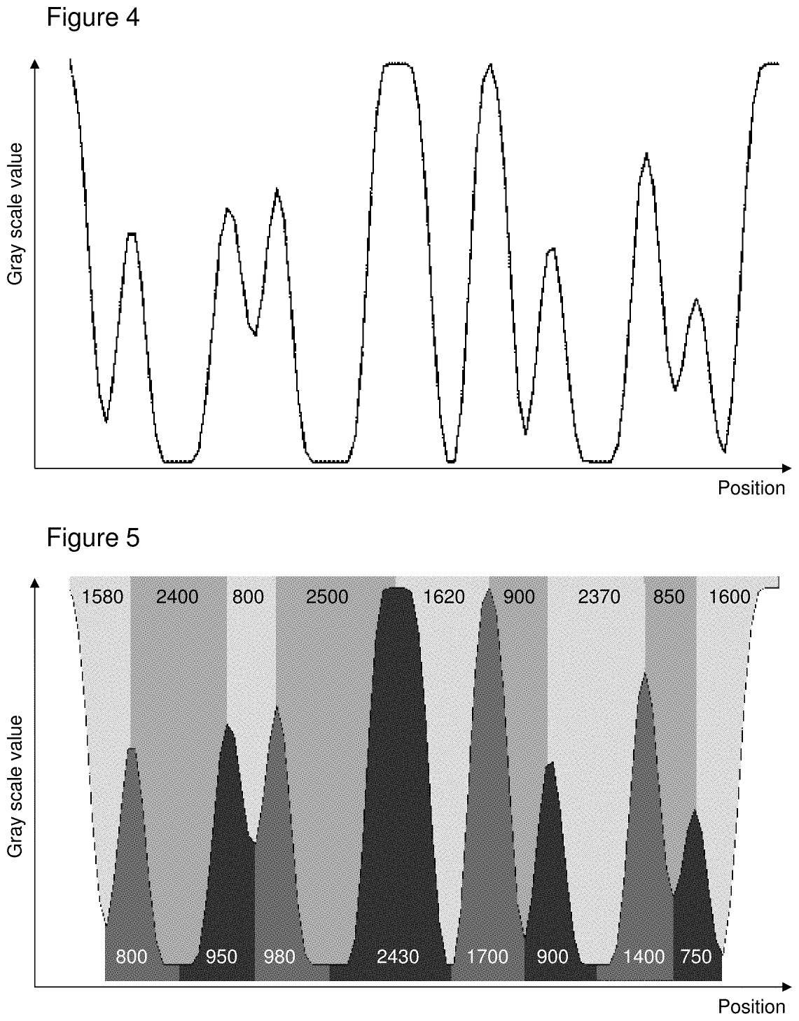

FIG. 4 a detail of a gray scale value profile;

FIG. 5 another representation of the gray scale value profile in accordance with FIG. 4, now with first and second sum measurements entered for the respective light and dark part regions of the optical code;

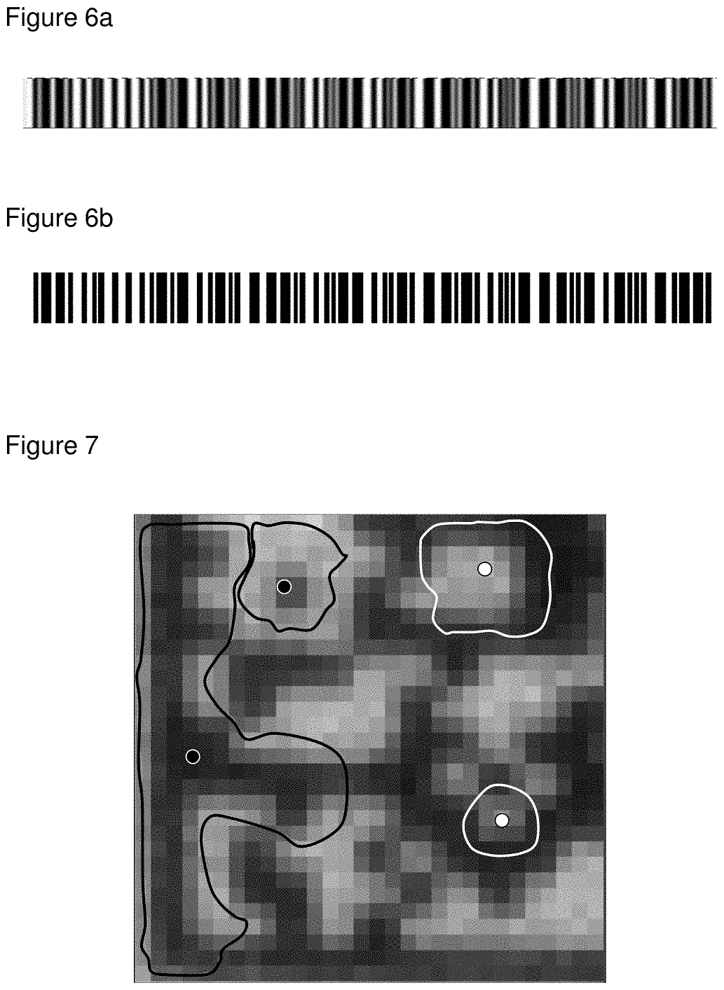

FIG. 6a a further example of a barcode recorded in washed out form;

FIG. 6b the reconstruction of the barcode in accordance with 6a using the method in accordance with the invention;

FIG. 7 an example of a 2D code with some light and some dark part regions for which sum measurements are determined up to a brightness boundary;

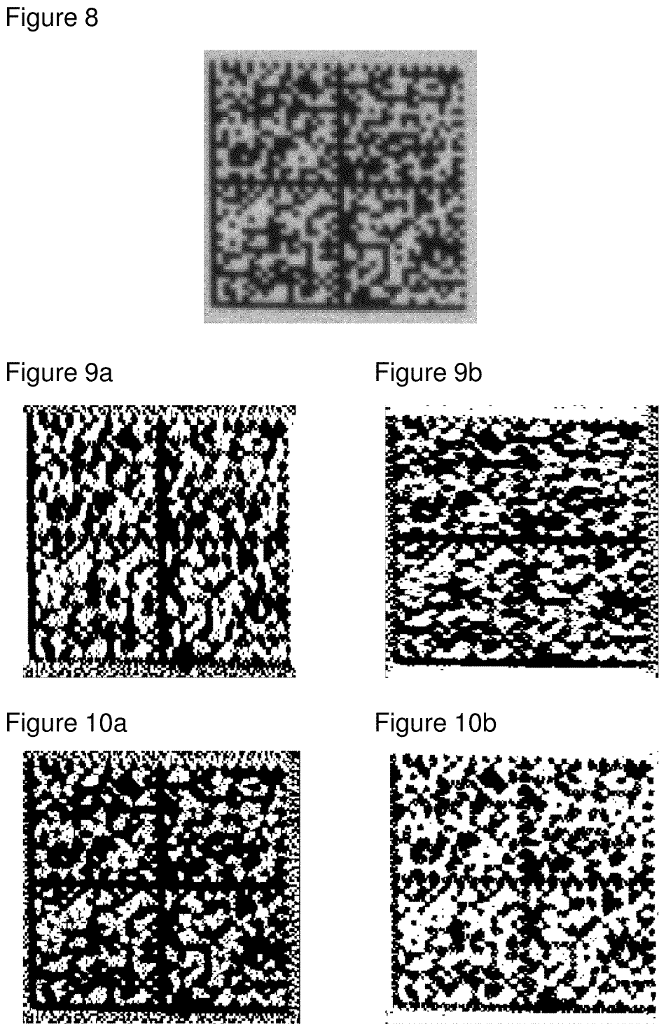

FIG. 8 a further example of a 2D code as a starting point for the further Figures;

FIG. 9a a reconstruction of the 2D code in accordance with FIG. 8 from sum measurements after a column-wise subdivision;

FIG. 9b a reconstruction of the 2D code in accordance with FIG. 8 from sum measurements after a row-wise subdivision;

FIG. 10a the logical AND link of the reconstructions in accordance with FIGS. 9a and 9b; and

FIG. 10b the logical OR link of the reconstructions in accordance with FIGS. 9a and 9b.

FIG. 1 shows an optoelectronic code reader 10 in a preferred situation of use mounted above a conveyor belt 12 that conveys objects 14, as indicated by the arrow 16, through the detection region 18 of the code reader 10. The objects 14 bear optical codes 20 on their outer surfaces which are detected and evaluated by the code reader 10. These optical codes 20 can only be recognized by the code reader 10 when they are affixed to the upper side or at least in a manner visible from above. Differing from the representation in FIG. 1, a plurality of code readers 10 can be installed from different directions for the reading of an optical code 22 affixed somewhat to the side or to the bottom in order to permit a so-called omnireading from all directions. The arrangement of the plurality of code readers 10 to form a reading system mostly takes place as a reading tunnel in practice. This stationary use of the code reader 10 at a conveyor belt is very common in practice. The invention, however, first relates to the code reader 10 itself and to the method implemented therein for the decoding of codes so that this example may not be understood as restrictive.

The code reader 10 detects the conveyed objects 14 and their optical codes using a light receiver 24 and the corresponding brightness profiles or gray scale value profiles are further processed in a control and evaluation unit 26 to read the code content. It is not the specific detection process that is important for the invention so that the code reader 10 can be set up in accordance with any principle known per se. For example, only one row is detected in each case, whether by means of a linear image sensor or in a scanning process, with a simple light receiver such as photodiode being sufficient in the latter case. A direct attempt can be made to read the code 20 from a linear detection or the control and evaluation unit 26 assembles the rows detected in the course of the conveying movement. A larger region can already be detected in a recording using a matrix-like image sensor, with the assembly of recordings here also being possible both in the conveying direction and transversely thereto.

The code reader 10 can output information such as read codes or image data via an interface 28. It is also conceivable that the control and evaluation unit 26 is not arranged in the actual code reader 10, that is the camera shown in FIG. 1, but is rather connected as a separate control device to one or more code readers 10. The interface 28 then also serves as a connection between an internal and external control and evaluation. The control and evaluation functionality can be distributed practically as desired over internal and external modules, with the external modules also being able to be connected via a network or cloud. No further distinction is made of all this here and the control and evaluation unit 26 is understood as part of the code reader 10 independently of the specific implementation.

FIGS. 2a and 2b respectively show a recording of a problematic optical barcode. In FIG. 2a, the barcode is washed out, the boundaries between the light and dark bars, lines, or part regions are poorly defined. In FIG. 2b, the barcode has insufficient resolution and therefore appears as coarse-grained. As described in the introduction, such codes can create problems in a conventional decoding process; they are possibly not read due to the poor detection quality. The method in accordance with the invention now to be described is more robust and in many cases nevertheless able to decode the code content. The explanation initially remains with the example of barcodes, but the method in accordance with the invention can analogously be transferred to 2D codes which will then subsequently be looked at with reference to FIGS. 7-10b.

FIG. 3 shows a brightness profile or gray scale value profile of the washed out barcode in accordance with FIG. 2a. In this brightness profile, the respective brightnesses, for example the values from 0 to 255 in an 8 bit encoding of the brightness or of the gray scale value, are applied transversely to the barcode with respect to the position on a line. The consideration of a brightness profile or gray scale value profile is not a real restriction. Optical codes comprise regions in two modalities, frequently black and white colors sometimes structures or characteristics, but in any case the code information can be detected by gray scale value images. It is also not important for the understanding of the invention whether the gray scale value profile is detected as a scan of a barcode scanner, an image row of a linear image sensor, or a line drawn through a planar image of the code 20.

For better clarity, FIG. 4 again shows a smaller section of a brightness profile of a barcode with washed out modules. In the ideal case, this would be a step function that in each case abruptly changes from a minimal level to a maximum level, or vice versa, which is here marked in simplified form as black and white and is reproduced, for example, by gray scale values 0 and 255. The objective of the method in accordance with the invention is ultimately to restore this ideal state or to read the code as if this ideal state were present.

The washed out detection of the barcode could be compensated at least in part by methods known from image processing, for instance by algorithmic resharpening or an image processing filter. This is conceivable in accordance with the invention as a pre-processing step. The resharpening or filtering could, however, on the one hand, change transitions in a manner that would ultimately lead to an incorrect reading. On the other hand, artifacts would also remain after such a pre-processing as a rule.

FIG. 5 uses the brightness profile of FIG. 4 to illustrate its evaluation with the aid of sum measurements or integrals in an embodiment of the invention. Viewed energetically, it can be stated as the starting point that the same remitted light quantity is always detected by the light receiver 24 from the light part regions, light bars, or gaps of a barcode independently of the resolution or of the pixel density. In the case of artifacts such as insufficient focusing, too low a sampling rate, or motion artifacts, this light quantity is distributed as required to a plurality of pixels and is superposed with the remitted light of different part regions of the barcode. The total light quantity of the light part regions remains the same here and this means that the integral over the brightness profile does not depend on whether and to what extent the barcode is recorded as washed out or with too low a resolution. Under the assumption that the dark part regions do not remit any light, the named integral corresponds to the sum of the light of all the light part regions.

It may now further be assumed that the artifacts remain local at least to the extent that light of a light part region only illuminates the adjacent part regions, but not more remote part regions. However, then the integral over the brightness profile in the region from a dark part region to the next dark part region that comprises exactly to one light part region has to correspond exactly to the light quantity remitted by the light part region. The trick here is that this is a summary observation and the integral of specific brightness extents such as flatter or steeper flanks or of other irregularities is only influenced a little.

Corresponding first sum measurements for the light part regions are entered at the bottom in FIG. 5 by way of example. In this respect, integration took place in each case from minimum to minimum of the brightness profile. The respective area corresponding to the integral is shaded dark, with two different gray shades being used purely for illustration. It is not necessary to integrate exactly between two minima since the starting and end values of the integration are anyway in a dark part region and therefore hardly contribute to the integral.

The same idea can be transferred to the dark part regions in that the inverted brightness profile is looked at. Inversion can be understood as a mirroring at the X axis or by calculation as a multiplication by −1. To avoid the negative values that thereby arise, the maximum level can subsequently be added everywhere to the inverted brightness profile, that is, for example, the value 255 with an 8 bit encoding of the brightness values. The integration limits are in turn the minima in the inverted brightness profile and accordingly the maxima in the non-inverted brightness profile. Corresponding sum measurements for the dark part regions are entered at the top in FIG. 5. The respective area corresponding to the integral is shaded bright, with two different gray shades also being used here purely for illustration.

The assumption that light remitted from a light part region only influences the directly adjacent dark part regions can also be relaxed. A matching light portion can then also be assigned to every light part region and the principle can still be used analogously, correspondingly for the dark part regions. The integral boundaries do not therefore necessarily have to be fixed to directly adjacent minima or maxima.

The result of the described evaluation is a plurality of first sum measurements and second sum measurements, in each case a first sum measurement per light part region and a second sum measurement per dark part region of the barcode. These sum measurements can now be alternatingly combined to form a sequence. With a homogeneous illumination of the barcode, the sum measurements for each part region having an extent corresponding to a specific multiple proportional to the module size It must be remembered here that the module size describes the extent of the smallest bar of the barcode and the extent of all the bars amounts to a respective multiple of the module size is the same. Decoding can be understood as a classification that seeks these multiples since the code information is actually located therein. Instead of measuring the width of the bars as customary, in accordance with the invention the sum measurements or integrals are used that likewise include the information required for a decoding in accordance with the above statements.

In the example of FIG. 5, the following alternating sequence of integrals or sum measurements results, read alternately from the top and the bottom: 1580, 800, 2400, 950, 800, 980, 2500, 2430, 1620, 1700, 900, 2370, 1400, 850, 750, 1600. With a perfect invariance of the integrals, this would be multiples of a largest common divisor that can serve as a reference value and that is in turn proportional to the module size. There is only a proportionality relationship and not any identity with the module size because sum measurements or integrals of the part regions were determined and not widths.

Any desired classifiers can be used to classify the example sequence. There are recognizably large differences between the sum measurement of bars of different widths so that the classification work becomes a lot easier and more robust to solve than, for example, with widths that are subject to great fluctuation due to washed out edges. The smallest sum measurement could, for example, be selected as the reference value or the i smallest sum measurements are averaged. i here should be small enough to not dilute the average value by an integral from a wider bar.

The sequence 2, 1, 3, 1, 1, 1, 3, 3, 2, 2, 1, 1, 3, 2, 1, 1, 2 results from the above exemplary sequence using such a classification that can also be understood as a standardization or discretization. This is the decoding result in accordance with the invention that is actually correct for the section of the barcode shown in FIGS. 4 and 5.

FIGS. 6a-b illustrate this again for a complete exemplary code. FIG. 6a shows the original, washed out recording of the barcode while 6b shows a restored barcode corresponding to the decoding from sum measurements or integrals. It is not important here that the bars are shown as sharp in FIG. 6b, this is due to the restoration, but rather that the bar widths exactly reproduce the washed out barcode in FIG. 6a. In conventional decoding methods, there would here be differences from the real code content due to which the barcode could not possibly be read at all.

FIG. 7 shows an exemplary 2D code to which the method previously explained for barcodes will now be applied or expanded. The detected gray scale values of the 2D code now form a two-dimensional brightness profile. Two exemplary maxima in light part regions are marked by white dots and two exemplary minima in dark part regions are marked by black dots. A respective associated white line or black line indicates a matching integration boundary. It lies where, starting from a white dot, a brightness threshold is respectively fallen below for the first time or, starting from a black dot, is exceeded for the first time. Two different brightness thresholds can be set for light part regions and dark part regions, the brightness thresholds can in particular be selected as very low or very high and can thus increase the robustness. A maximum is then surrounded by a dark edge sequence and a minimum by a light edge sequence.

There is also a module size as a smallest extent of a code element in a 2D code, but it now applies in two dimensions and thus defines a least square. A determination can be made via the sum measurements as to how many of these least squares form a light part region or a dark part region respectively. In contrast to a one-dimensional case, this is, however, alone not sufficient for decoding since the arrangement in, for example, a long row, a compact block, or any intermediate shape is not unambiguous without additional spatial information. The summary information on the number of smallest squares per part region can be decisive as an additional information source of whether a code is still read, for example to parameterize or plausibilize a different decoding process.

To enrich the summary information and provide a greater spatial reference, 2D brightness profiles can be subdivided and an embodiment of the method in accordance with the invention is respectively applied to the subregions of the subdivisions. The divisor results are then subsequently assembled. Examples for such subdivisions are rectangles with n×m pixels, in particular selected in dependence on an estimated module size, and rows, columns, or slanted lines. Especially the subdivision into rows or columns has the advantage that the method described for barcodes can be directly applied thereto. It is conceivable to apply the method in accordance with the invention multiple times with different subdivisions and to link the results.

FIG. 8 shows a data matrix code recorded as washed out as an arbitrary representative of possible 2D codes. Advantageous embodiments should be illustrated by way of example for this example.

In FIG. 9a, subdivisions or integrations are carried out column-wise, that is the method explained above with respect to barcodes is applied in every column. In FIG. 9b, subdivision or integration was carried out row-wise. The results differ; they are dependent on the selected subdivision. Respective classification or decoding attempts on both results are one possibility of dealing with this. It is furthermore conceivable to prepare the results by image processing algorithms.

FIGS. 10a and 10b illustrate a further possibility in which previous results are logically linked. The column integration image of FIG. 9a and the row integral image of FIG. 9b are specifically logically AND linked here by way of example and are logically OR linked in FIG. 10b. The direction dependence can be resolved in this manner and the result further improved.

1. A method of reading an optical code in which a brightness profile of the code is recorded, light and dark part regions are identified in the brightness profile, and the code content of the optical code is read, wherein first sum measurements for the light quantity in the respective light part regions and second sum measurements for the light quantity lacking for a white level in the respective dark part regions are determined from the brightness profile and the code content is read based on the first and second sum measurements.

2. The method in accordance with claim 1,
wherein the respective brightness profile is summed between two of its minima for the first sum measurements.

3. The method in accordance with claim 1,
wherein the respective brightness profile is summed between two of its maxima for the second sum measurements.

4. The method in accordance with claim 1,
wherein the brightness profile is inverted and is compensated by an offset corresponding to the white level to determine the second sum measurement.

5. The method in accordance with claim 1,
wherein the first sum measurements and/or the second sum measurements are determined by integration.

6. The method in accordance with claim 1,
wherein the code content is determined from an alternating sequence of the first sum measurements and the second sum measurements.

7. The method in accordance with claim 1,
wherein the first sum measurements and the second sum measurements are classified.

8. The method in accordance with claim 7,
wherein the first sum measurements and the second sum measurements are classified with reference to a reference value estimated from at least one finest sum measurement.

9. The method in accordance with claim 1,
wherein the first sum measurements and the second sum measurements are divided by a reference value and then discretized.

10. The method in accordance with claim 9,
wherein the reference value is estimated from at least one finest sum measurement.

11. The method in accordance with claim 1,
wherein the optical code is a 2D code.

12. The method in accordance with claim 11,
wherein the first sum measurements and the second measurements are determined in an environment of minima or maxima up to a brightness boundary determined by a threshold value.

13. The method in accordance with claim 1,
wherein the brightness profile is divided into subsections in which respective first sum measurements and second sum measurements are determined.

14. The method in accordance with claim 13,
wherein the subsections comprise rectangular subsections, rows, or columns.

15. The method in accordance with claim 13,
wherein the brightness profile is divided multiple times into different subsections to determine first and second sum measurements multiple times; and wherein the results are offset or compared with one another.

16. The method in accordance with claim 15,
wherein the results are offset or compared with one another by a logical link.

17. A code reader for reading optical codes that has a light receiver for detecting a brightness profile of the optical code and a control and evaluation unit that is configured to identify light part regions and dark part regions in the brightness profile and to read the code content of the optical code,
wherein the control and evaluation unit is further configured to determine first sum measurements for the light quantity in the respective light part regions in the respective light part regions and second sum measurements for the light quantity lacking for a white level in the respective dark part regions from the brightness profile and to read the code content based on the first and second sum measurements.
